(19) United States
(12) Patent Application Publication
(10) Pub. No.: US 2009/0165116 A1
(43) Pub. Date: Jun. 25, 2009

(54) Methods And Systems For Providing A Trust Indicator Associated With Geospatial Information From A Network Entity

(76) Inventor: Robert P. Morris, Raleigh, NC (US)

Correspondence Address: SCENERA RESEARCH, LLC, 111 CORNING RD., SUITE 220, CARY, NC, 27518, US

(21) Appl. No.: 11/961,342

(22) Filed: Dec. 20, 2007

(51) Int. Cl. G06F 21/00

(52) U.S. Cl. 726/14

(57) ABSTRACT

Methods and systems are described for providing a trust indicator associated with geospatial information from a network entity. In one embodiment, first geospatial information identifying a first geospatial region reported as associated with a first network entity is received. The first geospatial information is included in a message from the first network entity. Second geospatial information is received from a second network entity associated with the first network entity. The second geospatial information identifies a second geospatial region verified as associated with the second network entity. A geospatial relationship between the first geospatial region reported as associated with the first network entity and the second geospatial region verified as associated with the second network entity is determined. A trust indicator identifying a level of trust associated with the first geospatial region is generated based on the determined geospatial relationship.

### BACKGROUND

A great deal of research and investment has and is being put into location-based services. In today's systems, the location of a device, whether a service user device or a service provider device, is currently determined by receiving information from the device and/or receiving location information from a proxy device or directory service.

Current techniques do not address whether the location information of a service provider is authoritative. A service can be easily configured to provide incorrect location information for itself. Proxy information such as from a router can be used to trace a path for a message that can help determine a region of origination of a message from a device, but cannot verify that the device is authorized to represent the region.

Accordingly, there exists a need for methods, systems, and computer program products for providing a trust indicator associated with geospatial information from a network entity.

### SUMMARY

Methods and systems are described for providing a trust indicator associated with geospatial information from a network entity. In one embodiment, first geospatial information identifying a first geospatial region reported as associated with a first network entity is received. The first geospatial information is included in a message from the first network entity. Second geospatial information is received from a second network entity associated with the first network entity. The second geospatial information identifies a second geospatial region verified as associated with the second network entity. A geospatial relationship between the first geospatial region reported as associated with the first network entity and the second geospatial region verified as associated with the second network entity is determined. A trust indicator identifying a level of trust associated with the first geospatial region is generated based on the determined geospatial relationship.

According to an aspect, a system for providing a trust indicator associated with geospatial information from a network entity is disclosed. The system includes an interface configured for receiving first geospatial information identifying a first geospatial region reported as associated with a first network entity. The first geospatial information is included in a message from the first network entity. The interface is further configured for receiving second geospatial information from a second network entity associated with the first network entity. The second geospatial information identifies a second geospatial region verified as associated with the second network entity. The system also includes an association manager component configured for determining a geospatial relationship between the first geospatial region reported as associated with the first network entity and the second geospatial region verified as associated with the second network entity. The system further includes a trust indicator engine component configured for generating a trust indicator identifying a level of trust associated with the first geospatial region based on the determined geospatial relationship.

In another embodiment, first geospatial information identifying a first geospatial region reported as associated with a first network entity is received. The first geospatial information is included in a message from the first network entity. A request for verifying the first received geospatial information associated with the first network entity is sent. A trust indicator identifying a level of trust associated with the first geospatial region associated with the first network entity is received. The message from the first network entity is processed based on the level of trust identified by the trust indicator.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a flow diagram illustrating a method for providing a trust indicator associated with geospatial information from a network entity according to an embodiment of the subject matter described herein;

FIG. 2 is a block diagram illustrating a system for providing a trust indicator associated with geospatial information from a network entity according to another embodiment of the subject matter described herein;

FIG. 3 is a message flow diagram illustrating a message flow in a system for providing a trust indicator associated with geospatial information from a network entity according to another embodiment of the subject matter described herein;

FIG. 4 is a block diagram illustrating a system for processing a message based on receiving a trust indicator associated with geospatial information from a network entity according to another embodiment of the subject matter described herein;

FIG. 5 is a message flow diagram illustrating a message flow in a system for providing a trust indicator associated with geospatial information from a network entity according to another embodiment of the subject matter described herein;

FIG. 6 is a message flow diagram illustrating a message flow in a system for providing a trust indicator associated with geospatial information from a network entity according to another embodiment of the subject matter described herein;

FIG. 7 is a message flow diagram illustrating a message flow in a system for providing a trust indicator associated with geospatial information from a network entity according to another embodiment of the subject matter described herein;

FIG. 8 is a message flow diagram illustrating a message flow in a system for providing a trust indicator associated with geospatial information from a network entity according to another embodiment of the subject matter described herein;

FIG. 9 a flow diagram illustrating a method for processing a message based on receiving a trust indicator associated with geospatial information from a network entity according to another embodiment of the subject matter described herein; and

FIG. 10 is a block diagram illustrating a system for processing a message based on receiving a trust indicator associated with geospatial information from a network entity according to another embodiment of the subject matter described herein.

### DETAILED DESCRIPTION

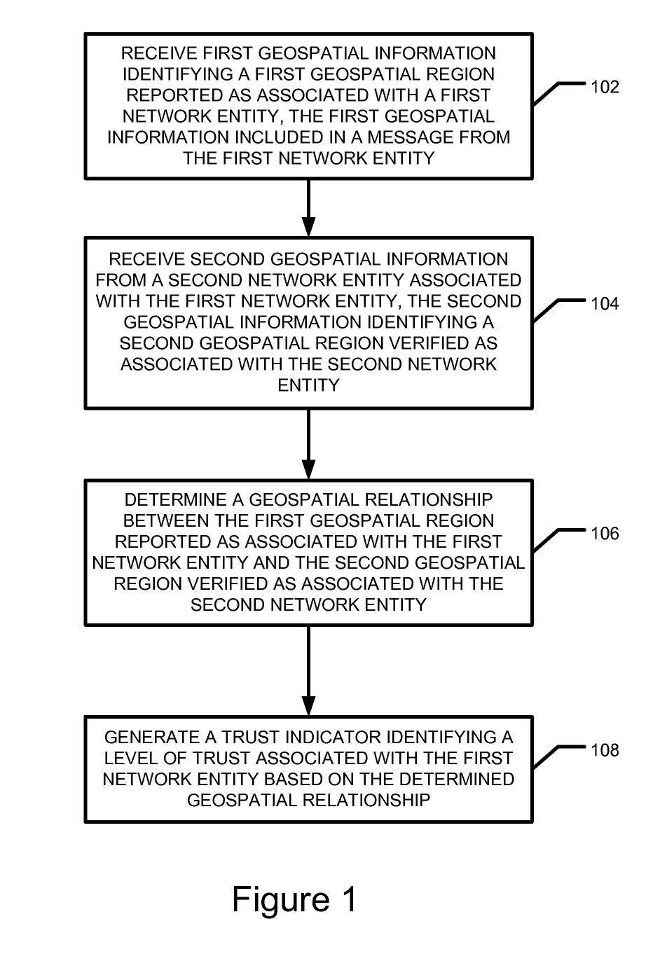

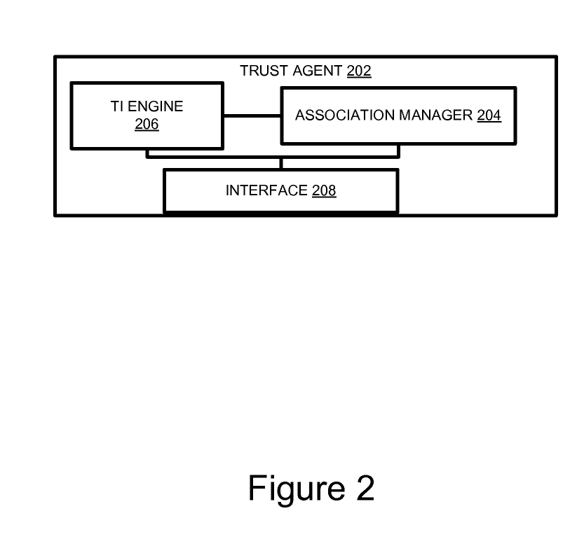

FIG. 1 is a flow diagram illustrating a method for providing a trust indicator associated with geospatial information from a network entity according to an exemplary embodiment of the subject matter described herein. FIG. 2 is a block diagram illustrating an arrangement of components at least a portion of which are for providing a trust indicator associated with geospatial information from a network entity according to another exemplary embodiment of the subject matter described herein. The method illustrated in FIG. 1 can be carried out by, for example, some or all of the components illustrated in the exemplary arrangement of FIG. 2.

With reference to FIG. 1, in block 102 first geospatial information identifying a first geospatial region reported as associated with a first network entity is received. The first geospatial information is included in a message from the first network entity. Accordingly, a system for providing a trust indicator associated with geospatial information from a network entity includes means for receiving first geospatial information identifying a first geospatial region reported as associated with a first network entity. For example, as illustrated in FIG. 2, a trust agent 202 includes an interface component 208 configured for receiving first geospatial information identifying a first geospatial region reported as associated with a first network entity.

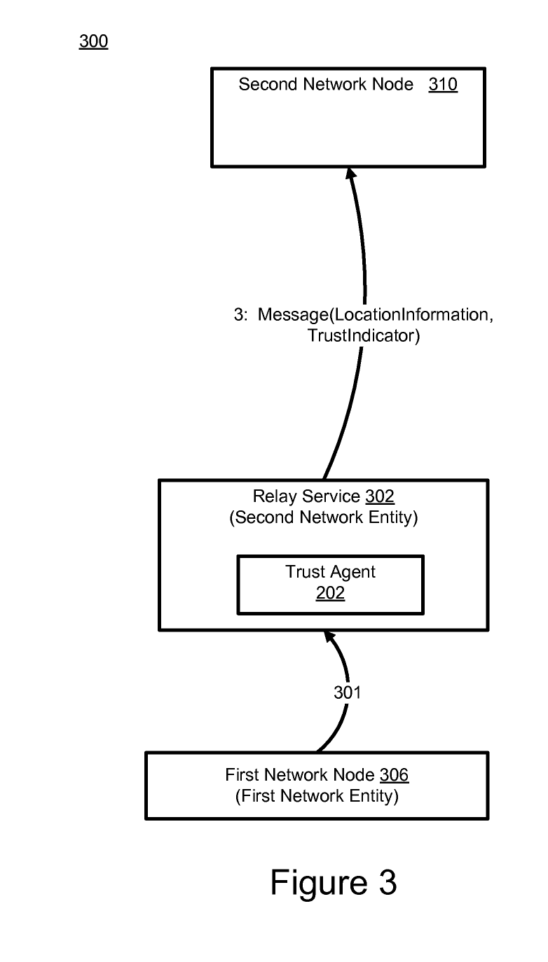

A portion of the components illustrated in FIG. 2 for performing the method can be hosted in a variety of execution environments provided by various types of devices. For example, an exemplary message flow diagram is depicted in FIG. 3 including a relay service 302. The relay service 302 can be configured for hosting the trust agent 202. The relay service 302 can be hosted by any device in a network path available for relaying a message 301 received from a first network node 306 to a second network node 310. Example devices that can host a relay service 302 include, but are not limited to, routers, bridges, hubs, switches, firewalls, network proxies, and virtual private network (VPN) concentrators

The interface component 208 of the trust agent 202 is configured for receiving the geospatial information included in the message 301 from the first network node 306. For example, the interface component 208 can be any component configured to receive data including the geospatial information. The first network node 306 represents an exemplary first network entity with respect to block 102 of FIG. 1. The first message 301 includes first geospatial information associated with the first network entity, which is the first network node 306 in the example of FIG. 3. The geospatial information can be associated with the first network entity as an identifier of a location of the first network node 306.

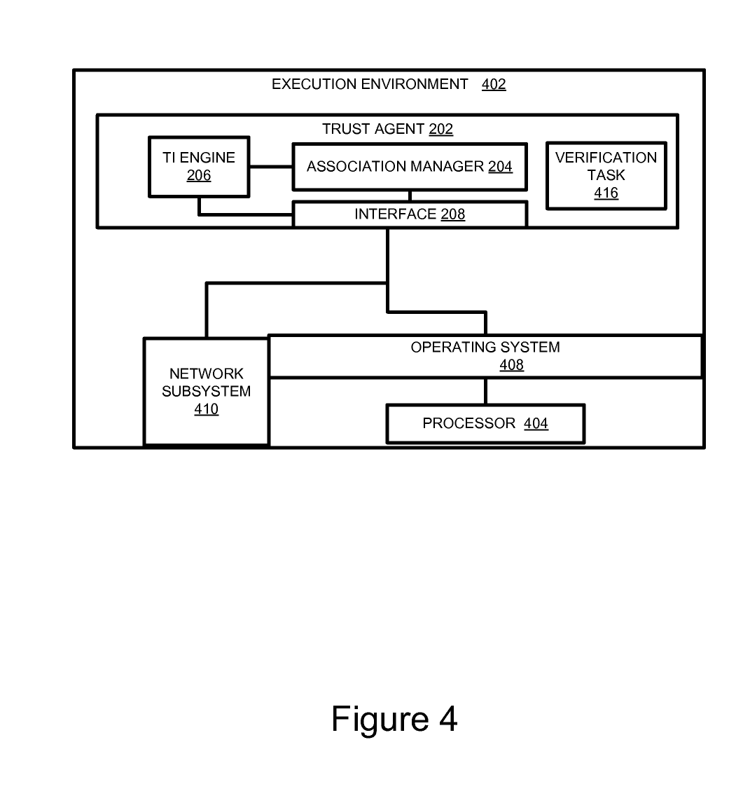

FIG. 4 is a block diagram illustrating an exemplary arrangement of components that can be employed for providing an execution environment 402 for an instance of the trust agent 202, where the trust agent 202 is adapted for operating in the execution environment 402. Any execution environment compatible with any adaptation of a trust agent is within the scope of the systems, methods, and program products described herein. The exemplary execution environment 402 includes a processor 404 for executing the instructions of the trust agent 202, an operating system 408 for providing access to resources when required by the trust agent 202. Further execution environment resources can include processor memory (not shown), threads/processes, a network subsystem 410 for communicating via a network, and any other services and resources required by the trust agent 202, all of which are well-known to those skilled in the art.

The trust agent 202 illustrated in FIG. 4 includes an arrangement of components for providing a trust indicator associated with geospatial information from a network entity according to another exemplary embodiment of the subject matter described herein. The method illustrated in FIG. 1 can be carried out by, for example, some or all of the components illustrated in the exemplary arrangement included in the trust agent 202 in FIG. 4.

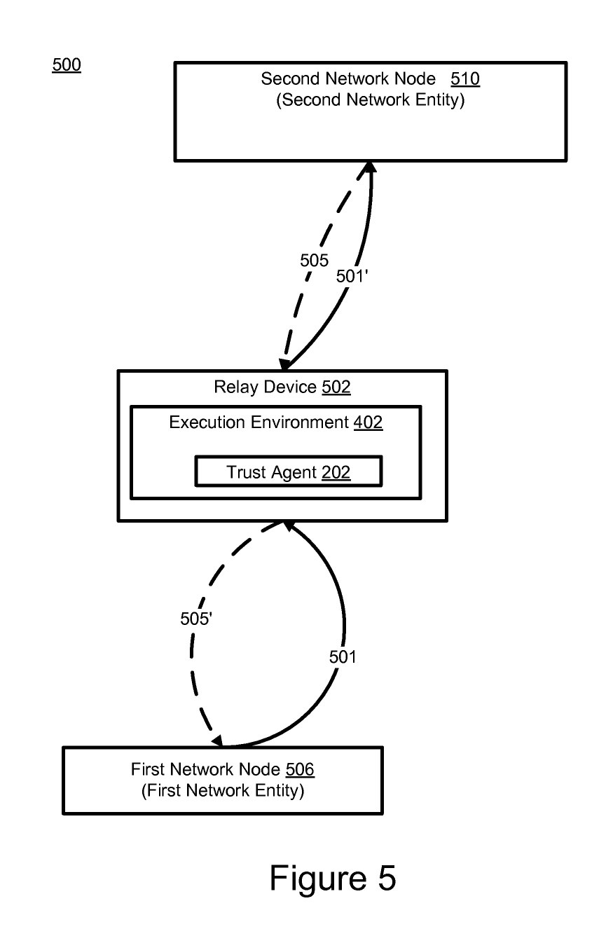

A message flow diagram 500 is shown in FIG. 5 for providing an exemplary illustration of the trust agent 202 in the particular arrangement of components in the diagram. The arrangement illustrated in FIG. 4 including the trust agent 202 is illustrated as included in a relay service 502, such as a relay server. The interface 208 of the trust agent 202 is configured for receiving a message, including the message 501 from a first network node 506. For example, the interface 208 can interface and communicate with components of the execution environment 402 outside trust agent 202. In FIG. 5, the first network node 506 represents the first network entity and the message 501 is received via a network (not shown) by the network subsystem 410. The trust agent 202 receives the message 501 from the network subsystem 410 via the interface 208. The network includes the relay service 502, the first network node 506, and the second network node 510. The message 501 can include geospatial information identifying a geospatial region associated with the first network node 506. The geospatial information included in the message 501 can be the first geospatial information identifying the first geospatial region associated with the first network node 506 as the first network entity. The geospatial information included in the message 501 can be associated with the first network node 506 as the first network entity in the first perspective. The geospatial information can identify a first geopolitical location under the authority of a first government.

According to an aspect, the interface 208 can also be configured for receiving the geospatial information included in a message 505 from a second network node 510. In this aspect, the second network node 510 represents the first network entity, and the message 505 represents the first message in the method 100. The second message 505 includes geospatial information identifying a geospatial region associated with the second network node 510. The geospatial information included in the message 505 can be associated with the second network node 510 as the first network entity in this aspect. The geospatial information can identify a second geopolitical location under the authority of a second government.

A message (such as the message 301, the message 501 and the message 505) can be any type of message including a request for content from a content provider, a response including content in response to a request, and a message received asynchronously such as a notification received without solicitation. For example, geospatial information can be included in a hypertext transfer protocol (HTTP) GET request and/or response. Alternatively or additionally, geospatial information can be included in an unsolicited message such as a notification defined in a presence call received in correspondence with a subscription or as a result of a directed publish message sent to a presence service.

Further, a message can be any data entity associated with any layer of a network including a link layer, a network layer, a transport layer, a session layer, a presentation layer, and an application layer. For example, geospatial information can be included in an extension header of an Ethernet packet, an Internet Protocol (IP) packet, and/or a Transmission Control Protocol (TCP) packet. The above paragraph provided examples of a higher layer protocol supporting the inclusion of geospatial information.

Geospatial information can be included in a message (such as the message 301, the message 501, and/or the message 506) in a variety of locations including a content portion, such as a payload of a message or packet; and/or a portion of a network protocol packet or stream, such as a header portion and/or a trailer portion. Examples of geospatial information in a protocol packet and/or packet payload are provided above. A trust protocol can be defined for sending geospatial information from a network entity to a trust agent. In such as protocol, the protocol can be specified with a format including a specified field, sequence of fields, and/or content identifiers. One or more fields, field sequences, and/or content identifiers can be specified for geospatial information.

The geospatial information in a message can be associated with a digital signature. The digital signature can be provided along with geospatial information for authenticating the sender and/or source of the geospatial information. Additionally or alternatively the digital signature can be provided as an indicator of precision, accuracy, and/or trust associated with the geospatial information. The digital signature can be associated with a digital certificate such as an X.509 digital certificate. Additionally or alternatively, geospatial information can be received in an encrypted message and/or can be received along with an encrypted message. The encrypted message can be provided for identifying a sender or source of the information, and/or its precision, accuracy, and trust.

Geospatial information received in a message can be expressed in a variety of formats and encodings. For example, geospatial information can include one or more of a Universal Transverse Mercator (UTM) coordinate, a World Geodetic System (WDS) 84 coordinate, a Cartesian coordinate, a postal address, and/or a geopolitical location identifier.

Returning to FIG. 1, in block 104 second geospatial information is received from a second network entity associated with the first network entity. The second geospatial information identifies a second geospatial region verified as associated with the second network entity. Accordingly, an arrangement of components for providing a trust indicator associated with geospatial information from a network entity includes means for receiving second geospatial information from a second network entity associated with the first network entity. For example, as illustrated in FIG. 2, the trust agent 202 component is configured for receiving second geospatial information from a second network entity associated with the first network entity.

Returning to the exemplary first message flow diagram 300 in FIG. 3 the relay service 302 can be configured for performing the role of the second network entity. The trust agent 202 is configured for receiving second geospatial information associated with the relay service 302. The relay service 302 can be configured for receiving the second geospatial location information and providing it to the trust agent 202. The second geospatial information can be received via a user interface configured for receiving configuration information from a user, read and/or imported from a file system and/or network system, and a location client configured for interoperating with a location service such as a system of GPS satellites. The relay service 302 (the second network entity) is associated with the first network node 304 (the first network entity). The first network entity and the second network entity can be associated, for example, via the path from the first network node 304 to the second network node 306 through the relay service 302. The second network entity can be associated with the first network entity based on a predefined relationship. For example, the predefined relationship can be based on the second network entity being included in a network path including the first network entity. In another example, the predefined relationship includes a client-service relationship. The association can be based on attributes including a distance, a business relationship, a related owner, a data exchange rate measure, a security relationship, and/or a service relationship between the first and second network entities.

The second geospatial information is verified as associated with the relay service 302. Verification can include a visual verification, an identifier of an owner, an associated government entity, a certificate including location information signed by a trusted party, a verification indication including a digital signature of a trusty entity.

With respect to the exemplary message flow diagram 500 in FIG. 5 the second network node 510 can be configured for performing the role of the second network entity with respect to the first network node in the role of the first network entity. The trust agent 202 can be configured for receiving the message 505 as a second message from the second network node 510 as a second network entity. The messages can be received by the trust system via the network subsystem 410 as described above. The second message can include second geospatial information associated with the first network entity, the first network node 506. The association can be a political relationship, such as a relationship as allies, cosigners of a treaty, trade partners, and/or enemies at war.

The second geospatial information can be verified as associated with the second network entity, the second network node 510, using any of the examples described above. Alternatively, verification can be performed via an analysis of a network path through which the message 505 was transmitted from the second network node 510 to the relay service 502. A verification task component 416 can be included in the trust agent 202 for receiving network path information. For example, the second geospatial information and a network address of the second network entity, the second network node 510, can be provided to the verification task component 416 by the trust agent 202. The verification task component 416 can be configured to issue one or more traceroute commands via the network subsystem 410 for routing by various routers in the network to determine a network path from the relay service 502 to the second network node 510. The verification task component 416 can be further configured for receiving location information associated with one or more routers identified in the received network path. For example, a query can be made to a domain name server (DNS) for resolving a network address to a geospatial location as associated by a LOC record stored in a DNS server database. An analysis of the geospatial information associated with the received network path can be performed by the verification task component 416 for verifying the second geospatial information and a level of confidence can be associated with the verification.

Additionally or alternatively, verification can be performed via a signal sent from the second device to a plurality of satellites and/or wireless receivers. One or more of the satellites can be configured for generating and sending a code to the second network device. One or more of the satellites can also be configured for providing the code along with geospatial information associated with the device by the plurality of devices receiving the signal to the relay service 302. The second device 510 can be configured for including the code in the message 505. The trust agent 202 can be configured to match the code received in the message 505 with the code received from the system of signal receivers. The trust agent can be further configured to determine whether the second geospatial information matches the geospatial information associated with the second network node 510 provided by the system of signal receivers.

Alternatively, the first network node 506 can be configured for performing the role of the second network entity with respect to the second network node in the role of the first network entity. The trust agent 202 can be configured for receiving the message 501 as a second message from a second network entity, the first network node 506. From this perspective, the message 505 can be received as a first message from a first network entity, the second network node 510. The second message 501 can include second geospatial information from the second network entity, the first network node 506. The association can be any of the associations described above. The second geospatial information can be verified using any mechanism available to the trust agent 202 including the examples described above.

A second network entity can be associated with the first network entity in a number of ways. For example, the second network entity can be associated with the first network entity as network node in a network path for delivering at least a portion of the message from a sender of the message to a receiver of the message. For example, as illustrated in FIG. 3, the first network node 306 as the first network entity is associated with the relay server 302 as the second network entity.

According to another example, the second network entity can be associated with a first network entity by being included in the same network. In particular, a second network entity included in a network with a relatively small geospatial region can increase a trust indicator's level of trust with respect to a second network entity in a same network as the first network entity where the same network is included in a relatively larger geospatial region. For example, a largest geospatial area that can be occupied by an Ethernet network is limited. Likewise, two network entities included in a same wireless network are both within a geospatial region served by the wireless network.

According to another example, the second network entity can be associated with the first network entity by a service where the second network entity can be one or more of a service provider, a service client, and/or a peer. Providing and/or using a service involves information exchange. The information exchange can be used to create an association. The information can include location information and/or trust information, for example. For example, a second network entity serving as a LAN manager for the first network entity is associated with the first network entity via the service provided. Services that can associate a second network entity with a first network entity include, but are not limited to, a domain name service, a data storage service, a security service, a web service, a time service, a communications service, a media service, a power service, a temperature conditioning service, a humidity service, and a lighting service. For example, the second network entity can be a security server and the first network entity can be included in a security domain of the second network entity.

According to an aspect, the second network entity can be associated with a trust indicator. The association of the second geospatial region with the second network entity can be based on the trust indicator associated with the second network entity. The trust indicator associated with the second network entity can include security information for authenticating and/or authorizing the second network entity, a network interface identifier identifying a network interface of the second network entity, and a digital signature generated by a third-party trust service.

Returning to FIG. 1, in block 106 a geospatial relationship between the first geospatial region reported as associated with the first network entity and the second geospatial region verified as associated with the second network entity is determined. Accordingly, a system for providing a trust indicator associated with geospatial information from a network entity includes means for determining a geospatial relationship between the first geospatial region reported as associated with the first network entity and the second geospatial region verified as associated with the second network entity. For example, as illustrated in FIG. 2, an association manager 204 component is configured for determining a geospatial relationship between the first geospatial region reported as associated with the first network entity and the second geospatial region verified as associated with the second network entity.

The trust agent 202 in the arrangement illustrated in FIG. 2 can include the association manager 204. The association manager 204 can be configured for receiving the first geospatial information and the second geospatial information from the trust agent 202. The association manager 204 is configured for determining a relationship between the first geospatial region and the second geospatial region associated with the first network entity and the second network entity respectively. The relationship determined can be based on a measure of distance, a measure of a rate of data exchange, a security relationship, and a topographic relationship between the first and second geospatial regions.

In the exemplary message flow diagram 300 in FIG. 3, the association manager 204 can be further configured for receiving optional information including a network identifier, a service, a business, an owner, and/or a geospatial attribute associated with one or more the first and second network entities.

The relay service 302 can be configured to provide a gateway service for a first network, such as an intranet or other subnetwork, providing access to a wide area network (WAN), such as the Internet. The first network can include devices that occupy a known geospatial region. The second geospatial information specifies the geospatial region including the first network. The association manager 204 can be configured to determine whether the first geospatial information identifies a geospatial location included in the geospatial region identified by the second geospatial information. This can be determined based on an intersection of the two regions. Thus, a purely geospatial relationship between the first geospatial region and the second geospatial region can be determined.

The association manager 204 illustrated in the exemplary message flow diagram 500 can be further configured to determine a first geopolitical region under control of the first government, and a second geopolitical region under control of the second government. Such a determination can be made, for example, via a table lookup and/or a remote procedure call to a service providing association information relating geopolitical regions and governments. The association manager 204 can be further configured for determining whether the first geospatial information identifies a location in the first geopolitical region under control of the first government and whether the second geospatial information identifies a location in the second geopolitical region under control of the second government. Thus a geospatial relationship between the first geospatial region and the second geospatial region is determined based each of the first and second geospatial regions' relationship with respect to the first and second geopolitical regions under control of the first and second governments, respectively.

As in the exemplary message flow diagram 300 in FIG. 3, the association manager 204 operating in the message flow diagram 500 can further be configured for receiving optional information including that described above for refining the determined geospatial relationship.

As indicated above, a geospatial relationship between a first geospatial region and a second geospatial region can be based on a measure of distance between the two regions. The measure of distance can be determined based on a communication between the first network entity and the second network entity. For example, a measure of distance can be calculated by sending a message from the relay service second network entity in the second geospatial region to the first network entity in the first geospatial region. The second network entity can receive a response to the first entity. Based on a measure of data throughput and time, measure of latency can be determined. A measure of distance can be determined based on the measure of latency. Alternatively or additionally, a measure of distance can be provided in a configuration, from a service, and/or calculated based on sending a wireless signal and detecting a reflection and/or receiving a response.

As further indicated above, a relationship between a first geospatial region and a second geospatial region can be based on topological data associated with one or more of the two regions. For example, first and second network entities can be wireless devices. The first and second regions can be separated by a topological feature such as mountain, building, and/or other structure including material through which it is known a wireless signal of the type supported by the two entities. If a signal is received by the second network entity including a trust agent, and the source is indicated to be the first network entity via a direct link, then the trust agent can determine that the signal is untrusted based on the known topological data.

Returning to FIG. 1, in block 108 a trust indicator identifying a level of trust associated with the first geospatial region based on the determined geospatial relationship is generated. Accordingly, a system for providing a trust indicator associated with geospatial information from a network entity includes means for generating a trust indicator identifying a level of trust associated with the first geospatial region based on the determined geospatial relationship. For example, as illustrated in FIG. 2, a trust indicator engine component 206 is configured for generating a trust indicator identifying a level of trust associated with the first geospatial region based on the determined geospatial relationship.

In the arrangement illustrated in FIG. 2 the association manager 204 is configured for providing relationship information based on the determined geospatial relationship to the trust indicator engine component 206. The trust indicator engine component 206 can be configured for generating any of a variety of trust indicator types. The various trust indicator types can be defined to identify any number of levels of trust. The trust indicator engine component 206 can be configured to generate a particular trust indicator type or types. A trust indicator type supported by the trust indicator engine component 206 can be based on a characteristic including the role of a device hosting a trust engine, a content type of the message from the first network entity, a service provided by one or both of the first and second network entity, and a relationship between the first and second geospatial regions.

As described above, the association manager 206 of the trust agent 202 included in the relay service 302 can determine whether a location identified by the first geospatial information is included in a region identified by the second geospatial information. The results of the determination can be provided to the trust indicator engine component 206. The trust indicator engine component 206 can be configured for generating a two-level trust indicator. A first level can be defined for associating an “untrusted” level with the first geospatial information, and a second level can be defined for associating a “trusted” level with the first geospatial information. When the received determination indicates that the location identified by the first geospatial information is included in the region identified by the second geospatial information, the trust indicator engine component 206 can generate a trust indicator including a second level identifier; otherwise a trust indicator including a first level identifier can be generated.

As described above with respect to FIG. 4 and FIG. 5, the association manager 204 of the trust agent 202 included in the relay service 502 can determine the geopolitical relationship between the first geopolitical region under control of the first government and the second geopolitical region under control of the second government. The association manager 204 can further determine whether the first geospatial region identified by the first geospatial information is in the first geopolitical region. Similarly, the association manager can determine whether the second geospatial region identifier the second geospatial information is in the second geopolitical region

The trust indicator engine component 206 can be configured for generating a multi-level trust indicator. A first level can be defined for associating an “unknown” level with a first network entity, a second level can be defined for associating an “untrusted” level with the first network entity, a third level can be defined for associating an “located” level with the first network entity, a fourth level can be defined for associating a “trusted” level with the first network, and a fifth level can be defined for associating a “certified” level with the first network entity.

When the trust agent 202 receives a first message, the association manager can be invoked by the trust agent 202 providing the first geospatial information. The association manager 204 can be configured for determining whether second geospatial information has been received in a previous second message from a second network entity. If no second geospatial information is located by the association manager 204, the association manager 204 can be configured for providing the first geospatial information along with any optional information available for which the association manager 204 and the trust indicator engine component 206 have been configured for processing in generating a trust indicator.

The trust indicator engine component 402 can be configured for invoking the verification task component 416 and providing the network address and first geospatial information associated with the first network entity to the verification task component 416. If the verification task component 416 indicates its analysis is inconsistent with the reported first geospatial information, the trust indicator engine component 206 can be configured for generating a trust indicator including an “untrusted” level. When the indication from the verification task component 416 indicates the analysis performed is consistent with the first geospatial information, the trust indicator engine component 206 can be configured for generating a “located” level trust indicator.

As illustrated in FIG. 5, the trust agent 202 can receive the generated trust indicator and include it in a message 501′ as a relayed version of the message 501 with the trust indicator included. Alternatively, the trust agent 202 can send the trust indicator to the second network node 510 and/or any other receiver via a separate message (not shown). When the trust agent 202 receives the second message, the association manager 204 can be invoked by the trust agent 202 providing the second geospatial information. The association manager 204 can be configured for determining whether first geospatial information has been received in a previous message from the first network entity. If no first geospatial information is located by the association manager 204, the association manager 204 can be configured for providing the second geospatial information along any optional information available to the trust indicator engine component 402. As described above the trust indicator engine component can generate one of an “untrusted” level trust indicator or a “located” level trust indicator based on its determination.

As described above, when both the first message and the second message have been received, the association manager 204 determines the geospatial relationship between the first geospatial region and the second geospatial region as reported by the first network entity as described above. The association manager 204 can provide the first geospatial information, the second geospatial information, relationship information, and any optional information based on the configuration of the trust indicator engine component 206 and/or the association manager 204. An “untrusted” level trust indicator can be generated as described above.

The trust indicator engine component 206 can be configured for generating a “located” trust indicator when the first geospatial information can be verified, but the geopolitical relationship associating the first and second network entities is neutral, for example, when two governments have little interaction but no substantial disagreements or conflict. If the geopolitical relationship is deemed to be negative, the trust indicator engine component 206 can be configured for generating an “untrusted” level certificate. Additionally or alternatively, if the first geospatial region is determined to be outside the first geopolitical region, the trust indicator engine component 206 can be configured for generating an “untrusted” level generated. If the first geospatial region is determined to be in the first geopolitical region, the second geospatial region is determined to be in the second geopolitical, and the geopolitical relationship is positive, the trust indicator engine component 206 can be configured for generating a “trusted” level trust indicator.

The trust indicator engine component 206 can be further configured to generate a “certified” trust indicator, rather than a “trusted” indicator, when the first message includes a certificate identifying the first network entity signed by a certificate authority under control of the second government. Those skilled in the art can see that other combinations of parameters exist whose values can affect the generating of a trust indicator.

Upon generating the trust indicator, the trust indicator engine component 206 can be configured to provide the trust indicator to the trust agent 202. The trust agent 202 can be configured for including the trust indicator in a message to the second network entity, the first network entity, and/or to any number of network entities configured for processing a trust indicator such as a network management entity as a third network entity. The message flow diagram 500 in FIG. 5 can be viewed from the perspective of the first network node 506 as the first network entity and the second network node 510 as the second network entity. The message 501, in this perspective, is the first message and the message 505 is the second message. Either of the first message 501 or the second message 505 can be received first by trust agent 202. The message flow diagram 500 can be interpreted from a reverse perspective with the second network node 510 as the first network entity and the first network node 506 as the second network entity. The two perspectives mirror one another in operation.

In one example the first network node 506 is the first network entity and the first message 501 is received first by the trust agent 202. As discussed above, the trust indicator engine component 206 can generate a trust indicator associated with the first network node 506 as the first network entity. The trust indicator can include a trust level of “untrusted” or “located”. When the message 505 is received from the second network node 510 as the second network entity, the trust agent 202 can generate a trust indicator as described above. A second trust indicator can be generated for the first network node 506 as the first network entity. The trust agent 202 can be configured for sending, via interface 208, the second trust indicator for the first network node 506 as the first network entity to the second network node 510 in a subsequent message received from the first network node 506 for relaying to the second network node 510. Alternatively, the trust agent 202 can generate a message and transmit the message via interface 208 and the network subsystem 410 and the network to the second network node. The message can be generated and sent without receiving a solicitation from the second network node and/or can be in response to a request from the second network note 510.

Switching perspectives, when viewed from the perspective of the second network node 510 as the first network entity and the first network node 506 as the second network entity and given the same sequence of messages described above, the trust agent 202 interoperating with the association manager 204 and the trust indicator engine component 206 can provide for a third trust indicator to be generated by the trust indicator engine component associated with the second network node 510 as the first network entity as described above. The third trust indicator can be included in the message 505′ indicating the message 505 as relayed by the relay service 502 to the first network node 506.

A trust indicator can include additional information related to the level of the trust indicator. For example, a trust indicator can include an indication of a method used for determining a trust level, a margin of error when measurements and calculations are involved, authentication information identifying the provider of the indicator, authorization information indicating a level of authority of the provider of the indicator, and or a identifier of a trusted entity associated with the determination of the indicator.

The second network entity can be associated with a trust indicator available to the receiver of the second geospatial information. The trust indicator can be generated based, at least in part, on the second network entity trust indicator. For example, if the second network entity trust indicator indicates the second network entity is untrusted, the trust indicator generated associated with the first network entity can be given a lower level of trust than when the second network entity is associated with a higher level of trust.

A level of trust can be determined based on a variety of factors. For example, a level of trust identified by a trust indicator can be determined based on a task associated with the first network entity. For example, if the first network entity is sending an instant message (IM) a higher trust level can be assigned, than if the first network entity is retrieving a file. The trust level can be used by an authorization service for determining whether the first network entity is provided authorization to perform the task. In another example, the level of trust can be determined based on trust indicators including a level of trust generated in the past. For a low trust network entity with a relatively low level of trust in the past with respect to a high trust network entity with a higher past trust level, a relatively lower level of trust can be generated, for the low trust network entity than the high trust network entity in similar situations.

Once a trust indicator identifying a trust level is generated, the first message can be processed based on the identified trust level. For example, as illustrated in FIG. 4, the operating system component 408 can be configured for processing the message based on the identified trust level. For example, and untrusted message can be quarantined, deleted, or otherwise disposed of. In contrast, a trusted message can be provided to an application for storage, presentation, or other processing.

According to an aspect, a mobile trust indicator can also be generated. For example, the first geospatial information can be received in a first sequence of geospatial informations identifiying a first sequence of geospatial regions including the first geospatial region. The first sequence of geospatial informations are received with a first sequence of time intervals between each pair of geospatial regions in the first sequence of geospatial regions. The second geospatial information can be received in a second sequence of geospatial informations identifying a geospatial region verified as associated with the second network entity in a second sequence of geospatial regions. As above, the second sequence of geospatial information can be received with a second sequence of time intervals between each pair of geospatial informations in the second sequence of geospatial regions. A relationship between each geospatial region in the first sequence of geospatial regions and a corresponding geospatial region in the second sequence of geospatial regions is determined. As described above a geospatial relationship can be determined between each first geospatial region and its corresponding second geospatial region. A sequence of trust indicators identifying a level of trust is generated. Each trust indicator is based on the corresponding determined geospatial relationship. A trust indicator can be generated as described above. The trust indicators can each identify a level of trust associated with a network entity and its reported geospatial information. A mobile trust indicator identifying a level of trust is generated based on the sequence of trust indicators. A mobile trust indicator can be generated based on at least a portion of the sequence of generated trust indicators. For example, a mobile trust indicator associated with a determined speed, path, and/or projected path can be determined based on a corresponding portion of the sequence of first mobile information, the associated sequence of time intervals, and the corresponding sequence of trust indicators.

For example, each trust indicator in the sequence can be generated based on previous geospatial information pairs in the sequence. The first geospatial information can be geospatial information from a device at a first time and the second geospatial information can be geospatial information from the same device at a second time, and vice versa. For example, a mobile device in a car can report first geospatial location placing it in South Carolina at a first time and report second geospatial information three hours later placing the car in Oregon. The trust indicator including a low level of trust can be determined for both the first geospatial information and the second geospatial information, with respect to each other.

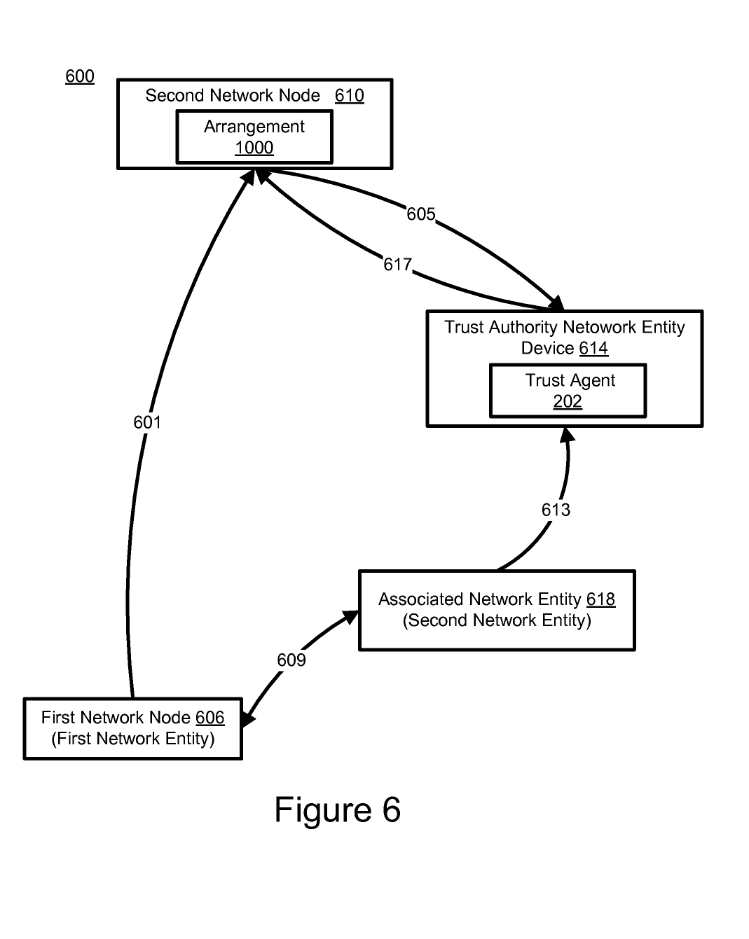

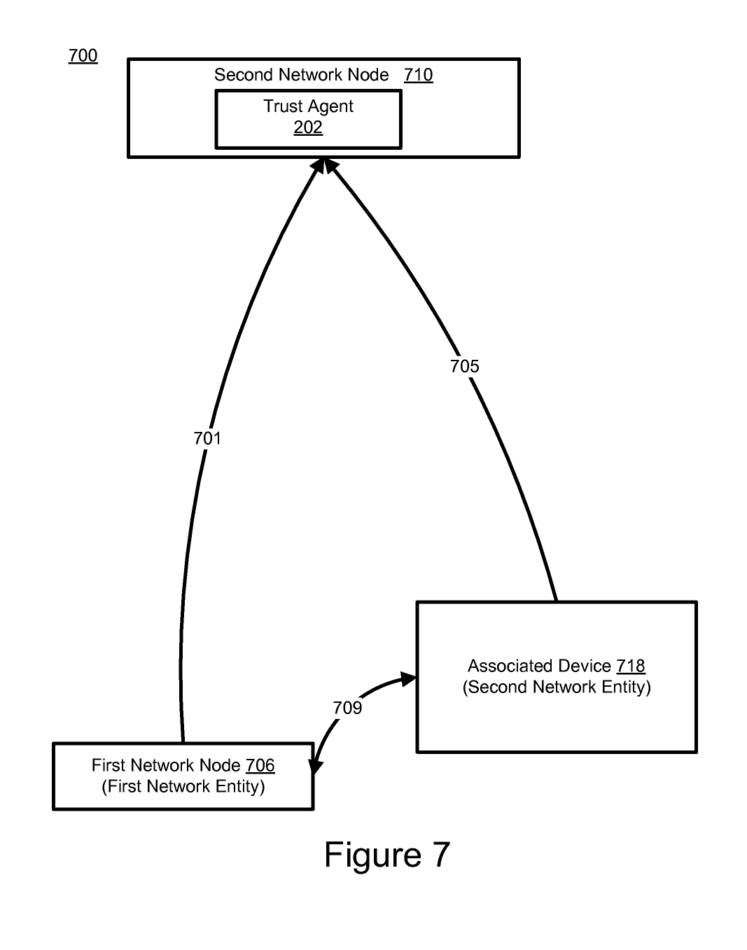

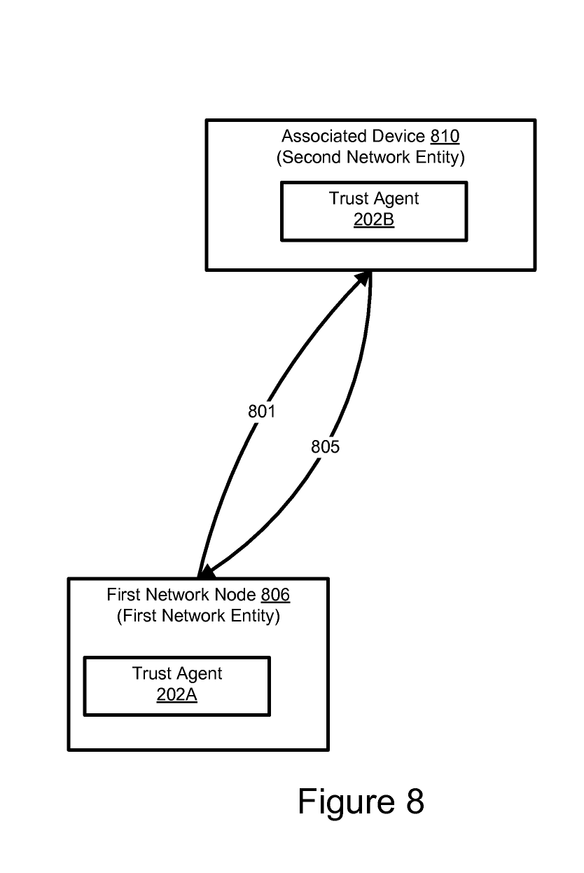

The arrangements of components and message flow diagrams in FIG. 2, FIG. 3, FIG. 4, and FIG. 5 are exemplary and are not intended to be exhaustive descriptions of the variety of component arrangements and message flows associated with performing the method 100. Additional exemplary message flow diagrams are depicted in FIG. 6, FIG. 7, and FIG. 8. Each is described below to provide additional exemplary examples from the many possible message flows and arrangements.

FIG. 6 depicts a message flow diagram 600 including an arrangement of components differing from the above arrangement described and depicted in FIG. 3 and FIG. 5. In FIG. 6, a trust agent 202 can be adapted for operating in an execution environment of a trust network entity (TNE) 614 for performing the method 100. The trust agent 202 includes an arrangement of components analogous to the arrangement of components in the trust agent 202.

The first network node 606 acting as the first network entity can send a message 601 to a second network node 610 via a network (not shown). The second network node 610 can receive the message 601. The message 601 can include first geospatial information from the first network node 606. The first geospatial information identifies a first geospatial region associated with the first network entity as reported in the message 601. The second network node 610 can be configured for sending the first geospatial information in a message 605 to the trust agent 202 operating in the TNE 614. The trust agent 202 can be configured for receiving the message 605 including the first geospatial information as reported from the first network entity, the first network node 606.

Prior to, during, and/or after sending the message 601, the first network node 606 can send a message 609 to an associated network entity 618 such as a service provider associated with sending the message 601. For example, the message 605 can include a query to a DNS service provided by the associated network entity 618 for resolving a host name associated with the second network node 610 to a network address of a network interface of the second network node 610. The message 601 can be addressed with the received network address. Alternatively, the service provider can be a security service provided by the associated network entity 618 for authenticating the first network node 606. In such a case, the message 609 is for authenticating the first network node 606. The message 609 can be sent before, during, and/or after the sending of the message 601. The message 609 can be sent by the first network node 606 unsolicited by the associated network entity 618 or can be sent in response to a request by the associated network entity 618. The associated network entity 618 and the first network entity can reside on the same LAN.

The associated network entity 618 can be configured for detecting the first network node 606 and reporting the presence of the first network node 606 on the LAN to a trust network entity (TNE) 614. The LAN can be included in a known geospatial region also reported to the TNE 614. The presence and additionally the location of the first network node can be reported to the TNE 614 in a message 613 by the associated network entity 618 as a second network entity. The second network entity is, in such an example, associated with the first network entity by being included in the same LAN. The TNE 614 can be configured for requesting the presence and location information (not shown). Additionally or alternatively, the TNE 614 can be a presence service where the associated network entity 618 serves as a presentity for network nodes on the LAN, such as the first network node 606. Thus, the message 613 can include a publish command and presence information for updating a presence tuple associated with the first network node 606. The architecture, models, and protocols associated with presence services in general are described in “Request for Comments” (or RFC) documents RFC 2778 to Day et al., titled “A Model for Presence and Instant Messaging” (February 2000), RFC 2779 to Day et al., titled “Instant Messaging/Presence Protocol” (February 2000), and RFC 3921 to Saint-Andre et. al., titled “Extensible Messaging and Presence Protocol (XMPP): Instant Messaging and Presence”, each of which are published and owned by the Internet Society and incorporated here in their entirety by reference.

As described above, the trust agent 202 can determine a geospatial relationship between the first geospatial region and the second geospatial region. The second geospatial region can be verified as associated with the second geospatial region based on a configuration accessible to the TNE 614. The configuration can include one or more trusted location information providers and their location. The associated network entity 618 can be included in the configuration along with the location of the associated network entity 618 and/or the region that includes the LAN.

The trust agent 202 can determine a geospatial relationship between the first geospatial region and the second geospatial region based on information reported to the TNE 614 by the associated second node 618. The information can include an indication that the first network node 606 is included in the same LAN as the associated network entity 618. Based on the indication the trust agent and be configured to determine, via a component or components analogous to the association manager 204, a distance between the first geospatial region and the second geospatial region. The determined distance can be checked by the trust agent 202 for consistency with the size of the LAN.

The trust agent 202 can then generate a trust indicator included a trust level determined based on the determined distance and a result of the consistency check involving the distance and the size of the LAN. The TNE 614 can send a message including the trust indicator associated with the first network entity to the second network node 610. The second network node 610 can be configured for processing the message 601 based on the received trust indicator.

FIG. 7 depicts a message flow diagram 700 including an arrangement of components differing from the above arrangements described, but similar to the arrangement of components in FIG. 7. In FIG. 7, there is no TNE component and a trust agent 202 is included in the second network node 710 rather than being included in a TNE. In FIG. 7 the trust agent 202 can be adapted for operating in an execution environment of the second network node 710 for performing the method 100.

The trust agent 202 in the second network node 710 can receive a message 701. The message 701 can include first geospatial information from the first network entity, the first network node 706. The first geospatial information identifies a first geospatial region associated with the first network entity as reported in the message 701. Prior to, during, and/or after sending the message 701, the first network node 706 can send a message 709 to an associated network entity 718 such as a service provider associated with sending the message 701 as described with respect to corresponding components and messages in FIG. 7. The associated network entity 718 and the first network entity can be associated as a presence service and a presence client, respectively.

The associated network entity 718 can be configured for detecting the first network node 706 and reporting the presence of the first network node 706 to subscribers of a presence tuple associated with the first network node 706. The trust agent 202 can receive a message 705 as notification including presence information associated with the presence tuple of the first network entity, the first network node 706. The message 706 can include second geospatial information in the presence tuple and/or in another portion of the message 705. The second geospatial information identifying a second geospatial region as a location of the first network entity as verified by the associated network device and/or the second geospatial information can identify a second geospatial region as a location of the associated network service 718.

As described above the trust agent 202 can determine a geospatial relationship between the first geospatial region and the second geospatial region via any suitable mechanism including those described in this document. The second geospatial region can be verified as associated with the second geospatial region via any suitable mechanism including those described in this document. The trust agent 202 can generate a trust indicator including a level of trust via any suitable manner including those described in this document.

FIG. 8 depicts a message flow diagram 800 including an arrangement of components differing from the above arrangements described. In FIG. 8, a first network node 806 can include a trust agent 202A that can be adapted for operating in an execution environment of the first network node 806 for performing the method 100. A second network node 810 can include a trust agent 202B that can be adapted for operating in an execution environment of the second network node 810 for performing the method of FIG. 1.

The trust agent 202 in each of the first network node 806 and the second network node can be configured for receiving geospatial information identifying a geospatial region associated with the other sending network node. The trust agent 202A can receive geospatial information associated with the second network node 810 in a message 805. Similarly, the trust agent 202B can receive geospatial information associated with the first network node 806 in a message 801. In a first perspective, the first network node 806 can be viewed as a first network entity with respect to the method 100. The message 805 is the first message received by the trust agent 202B including the first geospatial information. The trust agent 202B receives the geospatial information associated with the second network entity, the second network node 810, from the second network node 810. The second geospatial information identifying the second geospatial region is verified as associated with the second node in any suitable manner including, but not limited to, those discussed above. The trust agent 202B can then perform the remaining portions of the method using any mechanism suitable including those described in this document. Those skilled in the art will see that the second network node 810 can be viewed as a first network entity from a second perspective and that the trust agent 202A can perform the method in a manner analogous to that of the trust agent 202B.

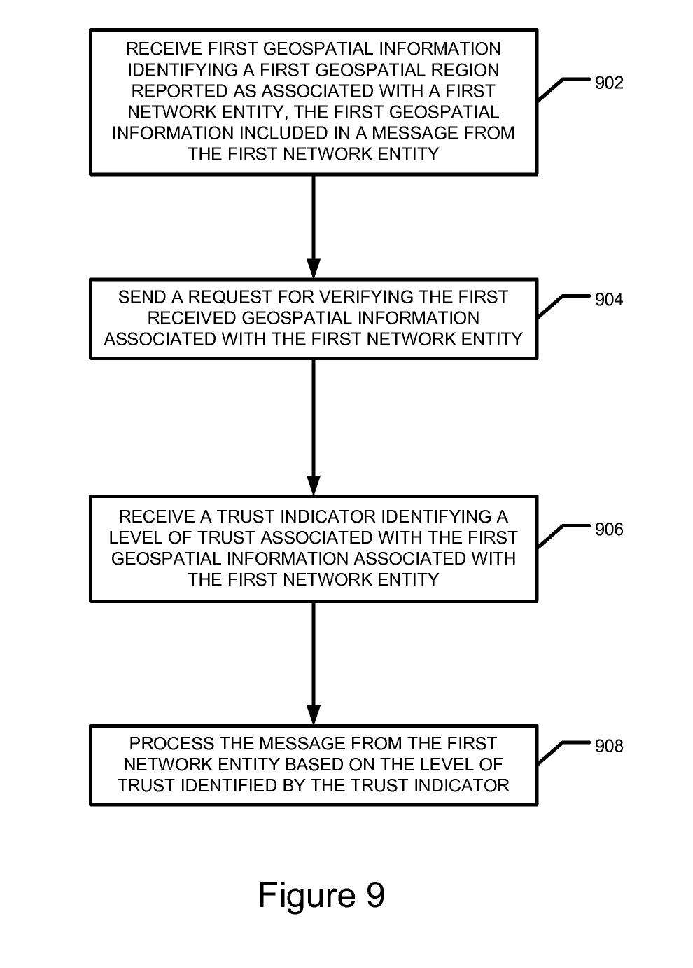

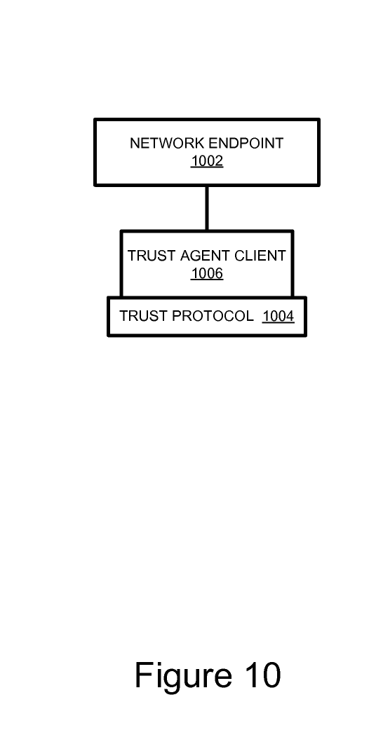

FIG. 9 illustrates a flow diagram illustrating a method for processing a message based on receiving a trust indicator associated with geospatial information from a network entity according to an exemplary embodiment of the subject matter described herein. FIG. 10 is a block diagram illustrating a system for processing a message based on receiving a trust indicator associated with geospatial information from a network entity according to another exemplary embodiment of the subject matter described herein. The method illustrated in FIG. 9 can be carried out by, for example, some or all of the components illustrated in the exemplary arrangement illustrated in FIG. 10.

With reference to FIG. 9, in block 902 first geospatial information identifying a first geospatial region reported as associated with a first network entity is received. The first geospatial information is included in a message from the first network entity. Accordingly, a system for processing a message based on receiving a trust indicator associated with geospatial information from a network entity includes means for receiving first geospatial information identifying a first geospatial region reported as associated with a first network entity. For example, as illustrated in FIG. 10, a network endpoint component 1002 component is configured for receiving first geospatial information identifying a first geospatial region reported as associated with a first network entity.

For example, referring again to FIG. 6, the arrangement of components illustrated in FIG. 10 can be adapted for operating in an execution environment provided by the second network node 610. The network endpoint 1002 is configured for receiving the first geospatial information identifying the first geospatial region as associated with the first network node 606 as the first network entity via the message 601 as described above.

Returning to FIG. 9, in block 904 a request for verifying the first received geospatial information associated with the first network entity is sent. Accordingly, a system for processing a message based on receiving a trust indicator associated with geospatial information from a network entity includes means for sending a request for verifying the first received geospatial information associated with the first network entity. For example, as illustrated in FIG. 10, a trust protocol component 1004 is configured for sending a request for verifying the first received geospatial information associated with the first network entity.

As described above with reference to FIG. 6, the second network node 610 can send the message as a request for verifying the first received geospatial information associated with the first network entity. The network endpoint 1002 is configured for providing the first geospatial information and information associating the first geospatial information with the first network node 606 as the first network entity to a trust agent client 1006 for formatting the request for a trust protocol layer 1004. The trust protocol layer 1004 is configured for sending the request as the message 605 to the trust agent 202 included in the TNE 614. The trust agent 202 can generate a trust indicator including a level of trust as described above for verifying the first received geospatial information. For example, the request can include an identifier the first network node such as a name and/or network address.

Returning to FIG. 9, in block 906 a trust indicator identifying a level of trust associated with the first geospatial region associated with the first network entity is received. Accordingly, a system for processing a message based on receiving a trust indicator associated with geospatial information from a network entity includes means for receiving a trust indicator identifying a level of trust associated with the first geospatial region associated with the first network entity. For example, as illustrated in FIG. 10, a trust agent client component 1006 is configured for receiving a trust indicator identifying a level of trust associated with the first geospatial region associated with the first network entity.

For example, the trust agent client 1006 is configured for receiving the trust indicator generated by the trust agent 202. Referring again to FIG. 6, the trust indicator can be received in a message 617 from the TNE 614. The message 617 is received by the trust protocol layer 1004 configured for providing the trust indicator to the trust agent client 1006.

Returning to FIG. 9, in block 908 the message from the first network entity is processed based on the level of trust identified by the trust indicator. Accordingly, a system for processing a message based on receiving a trust indicator associated with geospatial information from a network entity includes means for processing the message from the first network entity based on the level of trust identified by the trust indicator. For example, as illustrated in FIG. 10, a trust agent client component 1002 is configured for processing the message from the first network entity based on the level of trust identified by the trust indicator.

Returning to the message flow illustrated in FIG. 6, the trust agent client 1006 can be configured for providing the trust indicator and/or the included level of trust associated with the first network node 606 as the first network entity to the network endpoint. Alternatively or additionally, the trust agent client 1006 can provide information identifying an operation for processing the received message 601 to the network endpoint 1002. The network endpoint 1002 based on the trust indicator, trust level, and/or operation identifying information can be configured for processing the received message 601 by performing an operation based on the information provided by the trust agent client 1006. Alternatively or additionally, the network endpoint 1002 can provide the message and the information based on the received trust indicator to another component (not shown) for processing the message from the first network entity based on the level of trust identified by the trust indicator.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions that can be performed by elements of a computer system. For example, it will be recognized that the various actions can be performed by specialized circuits or circuitry (e.g., discrete logic gates interconnected to perform a specialized function), by program instructions being executed by one or more processors, or by a combination of both.

Moreover, executable instructions of a computer program for carrying out the methods described herein can be embodied in any machine or computer readable medium for use by or in connection with an instruction execution machine, system, apparatus, or network entity, such as a computer-based or processor-containing machine, system, apparatus, or network entity, that can read or fetch the instructions from the machine or computer readable medium and execute the instructions.

As used here, a “computer readable medium” can be any medium that can contain, store, communicate, propagate, or transport the computer program for use by or in connection with the instruction execution machine, system, apparatus, or network entity. The computer readable medium can be, for example, but not limited to, an electronic, magnetic, optical, electromagnetic, infrared, or semiconductor machine, system, apparatus, network entity, or propagation medium. More specific examples (a non-exhaustive list) of the computer readable medium can include the following: a wired network connection and associated transmission medium, such as an ETHERNET transmission system, a wireless network connection and associated transmission medium, such as an IEEE 802.11(a), (b), or (g) or a BLUETOOTH transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

Thus, the subject matter described herein can be embodied in many different forms, and all such forms are contemplated to be within the scope of what is claimed. It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for providing a trust indicator associated with geospatial information from a network entity, the method comprising:
receiving first geospatial information identifying a first geospatial region reported as associated with a first network entity, the first geospatial information included in a message from the first network entity;
receiving second geospatial information from a second network entity associated with the first network entity, the second geospatial information identifying a second geospatial region verified as associated with the second network entity;
determining a geospatial relationship between the first geospatial region reported as associated with the first network entity and the second geospatial region verified as associated with the second network entity; and
generating a trust indicator identifying a level of trust associated with the first geospatial region based on the determined geospatial relationship.

2. The method of claim 1 wherein the geospatial information is included in at least one of a content portion of the message and a network protocol portion of the message.

3. The method of claim 1 wherein the second network entity is associated with the first network entity based on a predefined relationship.

4. The method of claim 3 wherein the predefined relationship is based on the second network entity being included in a network path including the first network entity.

5. The method of claim 3 wherein the predefined relationship includes a client-service relationship.

6. The method of claim 1 wherein the second network entity is associated with a second network entity trust indicator for verifying the association of the second geospatial region with the second network entity.

7. The method of claim 1 wherein the geospatial relationship is determined based on a communication between the first network entity and the second network entity.

8. The method of claim 7 wherein the generated trust indicator is generated based on the second network entity trust indicator.

9. The method of claim 1 wherein the level of trust is determined based on a task associated with the first network entity.

10. The method of claim 1 wherein the message includes content and the content is processed based on the generated trust indicator.

11. The method of claim 1 further comprising:
receiving the first geospatial information in a first sequence of geospatial informations identifiying a first sequence of geospatial regions including the first geospatial region, the first sequence of geospatial information received with a first sequence of time intervals between each pair of geospatial regions in the first sequence of geospatial regions;
receiving the second geospatial information in a second sequence of geospatial informations identifying a geospatial region verified as associated with the second network entity in a second sequence of geospatial regions, the second sequence of geospatial information received with a second sequence of time intervals between each pair of geospatial informations in the second sequence of geospatial regions;
determining a relationship between each geospatial region in the first sequence of geospatial regions and a corresponding geospatial region in the second sequence of geospatial;
generating a sequence of trust indicators identifying a level of trust, each trust indicator based on the corresponding determined geospatial relationship; and
generating a mobile trust indicator identifying a level of trust based on the sequence of trust indicators.

12. A system for providing a trust indicator associated with geospatial information from a network entity, the system comprising:
means for receiving first geospatial information identifying a first geospatial region reported as associated with a first network entity, the first geospatial information included in a message from the first network entity;
means for receiving second geospatial information from a second network entity associated with the first network entity, the second geospatial information identifying a second geospatial region verified as associated with the second network entity;
means for determining a geospatial relationship between the first geospatial region reported as associated with the first network entity and the second geospatial region verified as associated with the second network entity; and
means for generating a trust indicator identifying a level of trust associated with the first geospatial region based on the determined geospatial relationship.

13. A system for providing a trust indicator associated with geospatial information from a network entity, the system comprising:
an interface component configured for receiving first geospatial information identifying a first geospatial region reported as associated with a first network entity, the first geospatial information included in a message from the first network entity and configured for receiving second geospatial information from a second network entity associated with the first network entity, the second geospatial information identifying a second geospatial region verified as associated with the second network entity;
an association manager component configured for determining a geospatial relationship between the first geospatial region reported as associated with the first network entity and the second geospatial region verified as associated with the second network entity; and
a trust indicator engine component configured for generating a trust indicator identifying a level of trust associated with the first geospatial region based on the determined geospatial relationship.

14. The system of claim 13 comprising a trust agent component configured for locating the geospatial information in at least one of a content portion of the message and a network protocol portion of the message.

15. The system of claim 13 wherein the second network entity is associated with the first network entity based on a predefined relationship.

16. The system of claim 15 wherein the predefined relationship is based on the second network entity being included in a network path including the first network entity.

17. The system of claim 15 wherein the predefined relationship includes a client-service relationship.

18. The system of claim 13 wherein the second network entity is associated with a second network entity trust indicator for verifying the association of the second geospatial region with the second network entity.

19. The system of claim 13 wherein the association manager component is configured for determining the geospatial relationship based on a communication between the first network entity and the second network entity.

20. The system of claim 18 wherein the trust indicator engine component is configured for the generating the trust indicator based on the second network entity trust indicator.

21. The system of claim 13 wherein the trust indicator engine component is configured for determining the level of trust based on a task associated with the first network entity.

22. The system of claim 13 wherein the message includes content and wherein the system includes an operating system component configured for processing the content based on the generated trust indicator.

23. The system of claim 13 wherein:
the interface component is configured receiving the first geospatial information in a first sequence of geospatial informations identifiying a first sequence of geospatial regions including the first geospatial region, the first sequence of geospatial information received with a first sequence of time intervals between each pair of geospatial regions in the first sequence of geospatial regions;
the interface component is configured for receiving the second geospatial information in a second sequence of geospatial informations identifying a geospatial region verified as associated with the second network entity in a second sequence of geospatial regions, the second sequence of geospatial information received with a second sequence of time intervals between each pair of geospatial informations in the second sequence of geospatial regions;
the association manager component is configured for determining a relationship between each geospatial region in the first sequence of geospatial regions and a corresponding geospatial region in the second sequence of geospatial;
the trust indicator engine component is configured for generating a sequence of trust indicators identifying a level of trust, each trust indicator based on the corresponding determined geospatial relationship; and
the trust indicator engine component is configured for generating a mobile trust indicator identifying a level of trust based on the sequence of trust indicators.

24. A computer readable medium including a computer program, executable by a machine, for providing a trust indicator associated with geospatial information from a network entity, the computer program comprising executable instructions for:
receiving first geospatial information identifying a first geospatial region reported as associated with a first network entity, the first geospatial information included in a message from the first network entity;
receiving second geospatial information from a second network entity associated with the first network entity, the second geospatial information identifying a second geospatial region verified as associated with the second network entity;
determining a geospatial relationship between the first geospatial region reported as associated with the first network entity and the second geospatial region verified as associated with the second network entity;
generating a trust indicator identifying a level of trust associated with the first geospatial region based on the determined geospatial relationship.

25. A method for processing a message based on receiving a trust indicator associated with geospatial information from a network entity, the method comprising:
receiving first geospatial information identifying a first geospatial region reported as associated with a first network entity, the first geospatial information included in a message from the first network entity;
sending a request for verifying the first received geospatial information associated with the first network entity;
receiving a trust indicator identifying a level of trust associated with the first geospatial region associated with the first network entity; and
processing the message from the first network entity based on the level of trust identified by the trust indicator.
